(19) United States
(12) Patent Application Publication
(10) Pub. No.: US 2007/0190210 A1
(43) Pub. Date: Aug. 16, 2007

(54) Food casing with a binder layer which comprises transferable additives

(76) Inventors: Martina Koenig, Wiesbaden (DE); Dirk Auf Der Heide, Alfhausen (DE); Gert Bueker, Illingen (DE); Marion Lunow, Illingen (DE); Hans-Peter Wolf, Ostercappeln (DE)

Correspondence Address: PROPAT, L.L.C., 425-C SOUTH SHARON AMITY ROAD, CHARLOTTE, NC, 28211-2841, US

(21) Appl. No.: 11/700,516

(22) Filed: Jan. 31, 2007

(30) Foreign Application Priority Data
Feb. 15, 2006 (DE) 10 2006 006 869.6
Jun. 14, 2006 (DE) 10 2006 027 493.8

(51) Int. Cl. A23L 1/31

(52) U.S. Cl. 426/105

(57) ABSTRACT

The invention relates to a single- or multilayer, flat or tubular food casing incorporating a carrier based on a water-insoluble, thermoplastic polymer, a polymer of animal or vegetable origin or regenerated or precipitated cellulose, and a coating. The carrier is a textile material or a film or a combination thereof. The coating includes binder and particulate foods with a mean particle size of 60 μm or more, optionally also food additives such as food colorings and liquid smoke. It additionally relates to a process for producing the casing and to its use as an outer casing for fish, meat and sausage products.

### CROSS-REFERENCE TO RELATED APPLICATIONS

This application claims priority to its parent applications, German Patent Application 10 2006 027 493.8, filed Jun. 14, 2006 and German Patent Application 10 2006 006 869.6 filed Feb. 15, 2006, which are hereby incorporated by reference herein, in their entirety.

### FIELD OF THE INVENTION

The invention relates to a single- or multilayer, flat or tubular food casing comprising a carrier based on a water-insoluble, thermoplastic polymer, on a polymer of animal or vegetable origin or on regenerated or precipitated cellulose, and a transferable layer. It additionally relates to a process for producing the casing and to its use.

### BACKGROUND OF THE INVENTION

Tubular food casings, especially artificial sausage skins, which comprise substances transferable to the food or the sausagemeat, such as food colorings, spices, aromas, flavorings or the like, are already known. For instance, EP-A 0 986 957 describes a casing comprising a layer based on polyolefin, polyester, polyvinylidene chloride (PVDC), polyvinyl chloride (PVC) or polystyrene, and a further layer intended for food contact. This inner layer comprises a polysaccharide and/or protein as a binder and—mixed with it—an aroma and/or flavoring. This is preferably a liquid barbecued-chicken aroma, honey, lemon oil or orange oil. The aroma or flavoring may also be a particulate solid, for example finely ground pepper. The average size of the particles is then generally from 0.5 to 50 μm, preferably from 1 to 30 μm.

WO 98/31731 discloses a quite similar food casing. Both documents state that the inner layer may additionally also comprise a crosslinker, for example a compound having at least two carbonyl groups. Particulate to coarse particulate or even piece-form aromas and/or flavorings are not mentioned.

EP-A 992 194 (=DE-A 198 46 305) provides a barrier casing comprised of a polymer material, the casing being lined on the inside with a layer of an absorbent material (wovens, loop-drawn knits or loop-formed knits) impregnated with dyes or aromas. In the course of cooking or scalding, the dyes or aromas are transferred to the food surrounded by the casing. The bond of the inner layer to the adjacent layer of the casing is generally effected by an adhesive. The barrier casing itself consists, for example, of polyamide and polyethylene layers. It is generally produced from a corresponding flat film by heat-sealing or adhesive bonding, and ensures the mechanical stability. A great disadvantage of this casing is that it cannot be pulled off completely, i.e. that parts of the inner layer remain on the food. The cause is considered to be an insufficiently mechanically stable bond between the polymer material and the textile inner layer.

The sausage casing according to DE-A 195 00 470 has, on the inside, an adhesive layer which solidifies from the liquid state, the casing material disclosed being plain-woven cotton fabric. Before the solidification, spice particles, especially peppercorns or ground pepper, are applied thereto. This is preferably done by spin-coating with special apparatus.

EP-B 0 408 164 describes a matrix material comprised of natural or synthetic fibers which is resistant toward water and heat. A layer of herbs, spices, seafood or milk products is applied to this matrix material in powder or chip form. The bond between the layer of the food and the matrix material is effected by an adhesive layer comprised of an edible water-soluble high molecular weight material which is suitable as a food additive. This adhesive layer comprises natural polysaccharides, carboxymethylcellulose-sodium, carboxymethyl starch or the like. According to this EP patent too, the transfer is achieved by a heat treatment.

WO 2004/094544 provides a food casing with which dark brown or black caramel color can be transferred uniformly and stably to the surface of a food, for example sausage, in order to impart to it a browned appearance. This purpose is served by a fractionated caramel mixture with a certain content of solid fractions, which has a molecular weight of greater than 10 000, and better peel-off from the encased food is also achieved when it is used. The base material used for the casing are fibrous and nonfibrous, natural or synthetic materials. The color layer is transferred over a prolonged residence time at unspecified temperatures.

It is also known to apply spices to foods using gelatin or starch as binders.

All the known casings with inner layers or inner coatings which comprise a transferable additive, and the application using gelatin or starch, have the disadvantage that their production is technically very complicated and labor-intensive, that they cannot transfer the additives in a sufficient amount or that they cannot be pulled off easily. Starch-containing casings are additionally very prone to microbiological contamination.

Tubular food casings comprised of regenerated cellulose, which may also be strengthened with a fiber paper inlay and then referred to as cellulose fiber skins or simply as fiber skins, have, owing to their proven good properties such as elasticity and strength, particularly at medium and large thicknesses, various uses in the foods sector, preferably where high permeability for steam and oxygen is desired, for example in the production of raw-meat sausage (especially of salami). However, it is difficult to achieve aroma transfer with solid substances in such casings.

### SUMMARY OF ADVANTAGEOUS EMBODIMENTS OF THE INVENTION

It is therefore an object of the present invention to provide a food casing which does not have the disadvantages mentioned.

The object is achieved by a food casing comprising a carrier based on a water-insoluble, thermoplastic polymer which has a layer of a binder with adhesive properties, on which foods or food additives are applied.

### DETAILED DESCRIPTION OF ADVANTAGEOUS EMBODIMENTS OF THE INVENTION

The present invention accordingly provides a single-layer or multilayer food casing comprising a carrier based on at least one water-insoluble, thermoplastic polymer, on a polymer of animal or vegetable origin (referred to hereinafter as “natural polymer”) or on regenerated or precipitated cellulose, which has a coating which comprises a binder and at least one additive which is transferable to the filling, wherein the additive consists of fine to coarse foods having a mean particle size of at least 60 μm.

The “foods” referred to as “additive” or “particulate additive” are all spices, vegetables, herbs, mushrooms, cereals and nuts, and cheese types in any form (for example grated, flaked, in pieces or molten, etc.), provided that they are used in fresh meat and fish processing or sausage and cheese production (this restriction also applies to the food additives mentioned below).

In contrast, foods which are to be encased by the inventive casing are referred to as “filling” or, where confusion with the aforementioned additives is ruled out, also as “foods”.

The binder is preferably virtually water-insoluble, but activable by heat treatment. In general, temperatures up to about 90° C. are sufficient for this purpose. The additive is then transferred to the filling present in the casing. However, it is also possible to select the binder such that the additives anchored therein are transferred to the encased material even at low temperatures.

It was surprising that it is also possible to provide foods in the raw state, which require particularly gentle treatment, with such additives in a simple manner with the inventive casing. This effectively replaces the expensive, labor- and time-intensive traditional coating. In addition to raw filling, it is also possible to provide sensitive foods, which have to be processed or stored with cooling, such as cooked ham, scalded-emulsion sausage and cooked-meat sausage, with the coatings desired in each case. It is thus also possible to access sectors in the foods industry which have to date not been accessible to such a coating process. Of course, it is also possible with the inventive casing to transfer other additives such as liquid smoke and/or food colorings.

The food casing may be flat or tubular. The coating is on the side facing the filling, in the case of a tubular casing accordingly on the inside. In a particular embodiment, the casing has a longitudinal seam.

The food casing according to the invention has the following advantages over the prior art. It is
simple to produce and
can take up a sufficient amount of particulate additives and transfer them to the filling.
The binder has good adhesion to the carrier materials mentioned and good adhesive power for the additives.
The coated carrier has high elasticity and can be removed again completely from the filling, while ensuring uniform transfer of the additives.
The casing has microbiological stability and high storage stability.
The casing has oxygen and steam permeability adjustable in a defined manner and
is usable both for foods which are processed at low temperatures and for those which are scalded, cooked or heated in another way in the casing.

Base materials for the food casing are generally water-insoluble, thermoplastic, synthetic polymers, such as polyolefin (PO), polyamide (PA), polyester, polyvinylidene chloride (PVDC), polyvinyl chloride (PVC) and/or polystyrene. However, the base material is preferably regenerated or precipitated cellulose. Cellulose casings can also be strengthened, preferably with a fiber paper with wet strength, especially a hemp fiber paper. Casings based on synthetic polymers may have one layer, for example casings based on polyolefin, preferably on polyethylene (PE), especially on linear low-density polyethylene (LLDPE), or have a plurality of layers, in which case the latter polymers optionally have adhesion promoter layers (AP) as intermediate layers. Examples include casings having a layer sequence of PA/PO/PA, PA/(PO+AP)/PA, PA/AP/PO/AP/PA or PE/AP/PA. Examples of usable adhesion promoters include polyolefins with functional groups, for example polyethylene grafted with maleic anhydride. It is also possible to use polymers of animal or vegetable origin, i.e. “natural polymers”.

The carrier may be a textile material comprised of one or more of the polymers of natural and/or synthetic origin mentioned. The term “textile material” should be understood to mean not only woven fabrics but also loop-drawn knitted fabrics, loop-formed knitted fabrics, laid fabrics, nonwoven fabrics, spunbonded fabrics and other flat materials comprised of fibers. Examples of textile carriers are viscose staple fabrics or viscose staple/polyester blend fabrics. The carrier may also be a film or a combination of textile material and film.

The binder or binder mixtures with which the food casing is coated are preferably virtually insoluble in cold and hot water (up to about 90° C.). If appropriate, they are made insoluble by suitable treatment, for example by heat coagulation. They are, for example, proteins or poly-saccharides or mixtures thereof. Especially suitable are cellulose derivatives, especially ethers or esters of cellulose, such as methylcellulose, and additionally alginic acid and/or alginate, chitosan, pectin, carrageenan or starch or starch derivatives, proteins such as gelatin and gelatin hydrolyzates, collagen, albumin, casein, zein, wheat protein, soya protein or pea protein, preferably blood hydrolyzate, blood plasma, myoglobin, protein hydrolyzates having molecular weights of from 5000 to 30 000 daltons, acid-boiled collagen with molecular weights of from 20 000 to 1 000 000 daltons, or desamidocollagen which is obtainable by alkaline hydrolysis. These binders which are insoluble or have been made insoluble in cold and hot water are applied in particular to textile carriers.

Suitable binders are also fats, waxes, oils or other hydrophobic, water-insoluble substances which soften or become liquid under the action of heat up to about 90° C., lose their adhesive power and hence bring about transfer of the additive. These may be tallows, drying oils, nondrying oils, semidrying oils, waxes, fatty acids, fatty acid esters, fatty alcohols or mixtures thereof. These hydrophobic substances may be blended with the aforementioned proteins, especially with heat-coagulable proteins. Lipids have the additional advantage that they, when they are also transferred, serve as a flavor enhancer for spices or other additives.

The binder is selected according to its adhesive power with respect to the carrier material of the casing and the additive which adheres on the binder. With the aid of the binders, it is additionally possible to adjust the adhesion and release properties of the casing to the particular filling in a controlled manner. The adhesion should generally be sufficiently strong that the casing does not become detached in the coarse of storage, but on the other hand sufficiently weak that it can be removed without any problem without constituents of the filling remaining adhered to it. The binders used are also notable in that they are firstly entirely flavor-neutral and secondly suitable for human consumption. The flavor of the filling and of the additives is not impaired.

To increase the elasticity, the wettability and the microbiological stability, it may be appropriate to combine the binder with at least one appropriate component. Suitable components for this purpose are lactic acid and its salts, for example sodium lactate, glycerol, emulsifiers such as lecithin and/or fats and oils. They ensure particularly uniform and continuous application of the binder. The proportion of the component in the coating or impregnating liquid is appropriately from 1.5 to 15.0% by weight, preferably from 2.0 to 8.0% by weight.

The casing according to the invention is particularly suitable for producing cooked-meat sausage or scalded-emulsion sausage. In this production, temperatures of from 75 to 90° C. (core temperature) are generally attained. In this temperature range, the binder is activated to such an extent that the transfer of the additive occurs without any problem. The casing may also be smokeable. In a further embodiment, it additionally has at least one outer coating which effectively reduces the steam and oxygen permeability. The outer coating comprises, for example, a polyvinylidene chloride (PVDC) resin. Suitable polymers for a steam barrier layer are generally polymers which contain units of at least one of the following monomers: vinyl acetate, vinyl alcohol, ethylene, butadiene, styrene, acrylic acid and/or methacrylic acid. The coating in the casings intended especially for scalded-emulsion sausage and cooked-meat sausage applications (after drying) generally have a weight of up to 150 g/m², preferably from 30 to 120 g/m². Problems as a result of delamination generally do not occur in the coated casings. They generally have a steam permeability of less than 150 g/m²·d, preferably less than 100 g/m²·d, and, for high-barrier requirements, less than 5 g/m²·d. The additional coating additionally allows the printability of the food casings to be improved.

In general, the additive has a firm consistency and has a grainy to coarse-grain, if appropriate also piece-form, particulate structure. In addition to the customary aromas and/or flavorings, such as pepper, coriander, curry, chilli, paprika, cinnamon, caramel or similar spices or spice mixtures, these also include garlic, onion, leek, carrots, paprika and pepper pods, celery, asparagus and other vegetables in any possible form, mushrooms, fruits (pineapple or apple pieces, carob), but also fresh or dried herbs, for example parsley or dill leaves, especially dill tips. Grated, flaked or molten cheese is also possible as an additive. In principle, the additive used can be anything which improves the taste or finishes meat, sausage, fish or cheese products.

However, the transferred additive may also be ground, in which case the mean particle size is generally 60 μm or more, preferably 70 μm or more. The maximum particle size may be up to 1.0 mm and more. The mean particle size is generally in the range from 60 to 800 μm, preferably from 70 to 500 μm, more preferably from 80 to 400 μm, quite specifically 90 to 250 μm. The particulate additives consist preferably of particles visible to the naked eye. The particles may have a spherical, elongated, platelet-shaped, rod-shaped or another regular or irregular shape.

The additive may, for example, be comminuted after preceding freeze-drying, so that a uniform, relatively thin and readily adhering coating can be produced.

In addition to the aforementioned additives, it is also possible for food additives, especially colorants, to be transferred. Preference is given to: caramel, food colorings E124 (Cochineal Red A), E155 (Brown HT), E120 (carmine), paprika oleoresin (E160C), concentrates and extracts from elder, plum or tomato, cereals (especially barley) and formulations thereof (such as malt or malt extract), carob seed flour, guar seed flour, coffee, chicory or cocoa, etc. The mean particle size of the food additive is generally less than 60 μm, for example liquid smoke.

The amount in which the additive is applied depends quite crucially upon its type. In most cases, it has been found to be appropriate to apply this substance in an amount of 3 to 150 g/m², preferably of 5 to 120 g/m². The total weight of the impregnation or coating after the drying is preferably from 10 to 200 g/m², in particular from 30 to 150 g/m².

The binder layer as a transfer layer for the additive is preferably applied in the form of an (aqueous) solution to the carrier material.

The additive is transferred from the binder layer to the filling during the scalding, cooking or other heating operation by virtue of the fact that, owing to the evolution of heat, the adhesion on the binder is reduced and the additive is released. To activate the binder, temperatures of from 30 to about 90° C. are sufficient.

In a particular embodiment, the binder used is a protein coagulable under the action of heat, such as whey protein, egg white protein or blood plasma, or fractions isolated or produced from the protein. After the coagulation, the protein is virtually insoluble in water. The coagulable protein can be combined particularly efficiently with a textile-based casing. In that case, the additives, i.e. the spices in particular, are applied to the protein layer. They can be applied as a uniform layer or else only in predetermined regions, i.e. imagewise. Subsequently, the protein is coagulated by heating and thus made virtually water-insoluble. The coagulation can be effected just as efficiently when the food is scalded or cooked in the casing. After the coagulation, the protein is additionally as good as no longer tacky. The coagulable protein can, however, also be applied to a film as a carrier material. In that case, as described, the additive, i.e. the spice in particular, is applied to the protein layer.

In order to prevent spice particles from becoming detached from the support in the course of further processing, another thin layer of a film-forming protein is appropriately applied to the spice layer. It has been found that collagen fibers are particularly suitable for this purpose. The carrier material thus coated can then be shaped to a tube whose longitudinal edges are bonded in a fixed manner to one another, preferably sewn to one another in a fixed manner.

The thin layer of a film-forming protein present on the spice layer simultaneously prevents spice particles from breaking out as the tubular food casing is filled. When the filled casing is then heated to temperatures as are customary in the production of scalded-emulsion sausage or cooked-meat sausage (i.e. to of from about 80 to 90° C.), the spice is transferred completely to the surface of the food present therein. This is especially true when the food is sausagemeat. In this case, a portion of the coagulated blood plasma commonly remains on the casing, while another portion has become bonded irreversibly to the meat, as can be determined after the removal of the casing. The blood plasma does not dissolve again when the food casing is processed. It also does not change under the action of water or steam.

Below room temperature, the additives are transferred preferably by intimate contact of the filling, especially under slight pressure, with the food casing. This transfer takes place even at temperatures below 15° C., preferably below 10° C. and in particular below 7° C. In general, the transfer time is less than 50 hours, preferably less than 40 hours, in particular less than 30 hours. The transfer time depends upon the individual case and can be determined by simple preliminary experiments.

In this transfer process, specific binders which become detached from the casing without action of heat and become bonded to the filling are used. Suitable substances are, for example, alkaline milk protein, methylcellulose and protein hydrolyzate.

In both aforementioned embodiments, an additional binder layer can be applied to the additive. The binder for this purpose can be identical to the binder layer below the additive. In general, this second adhesive layer consists of film-forming substances. In a preferred embodiment, the additional binder layer consists of a film-forming protein or a mixture of such proteins, more preferably of collagen fibers. The additional layer increases the binding of the additive to the meat and simultaneously fixes it on the carrier.

The invention further provides a process for producing the casing. The starting material used is generally a tubular casing comprised of a thermoplastic polymer or of cellulose, the casing being cut with a knife at one of the two layflat edges and then rolled up. This rolled material, in a second process step, is opened up by means of a forming shoulder to give a flat material in web form, and the inside is first coated with a binder, then with the appropriate particulate additive and subsequently dried in a drying channel at suitable temperature, depending on the type of binder and of the additive. If appropriate, the surface can be fixed and smoothed by placing a further binder layer over the particulate additive. Directly after the drying operation, the coated casing material which has been laid flat can be conducted over a further forming shoulder which brings it back into a round form. The longitudinal edges of the resulting carrier material which has been laid in a round shape can then be bonded to one another, especially by applying an adhesive tape, by adhesive-bonding the overlapping ends or by introducing a polyurethane band which is hardened with supply of heat or by UV light, or by sewing. The coated material then has a corresponding longitudinal seam.

The second rounding after the coating can also be dispensed with. In that case, a flat material is obtained, which can be used for the wrapping, for example, of relatively large or irregularly shaped filling. When the transfer of the particulate additive to the filling packaged therein by heating is desired, it can be done, for example, by UV rays or microwaves. For the transfer at low temperatures, such a coated flat material is appropriately used.

In a further variation of the production process, the starting material is a tubular, preferably seamless casing which is coated on the outside, provided with an additive, dried and, after the drying, reversed. In this way, an interior-coated casing is obtained. It consists preferably of polymer material, especially of polyamides and/or copolyamides.

The coating or impregnation of the food casing on the side facing the filling can be effected by processes which are in principle known to those skilled in the art. In a particularly simple process, the coating is applied to a corresponding flat material with the aid of a coating knife. However, other means known to those skilled in the art can also be used. The coated casing can then pass through a dryer as usual. If necessary, the casing is then brought to the desired final moisture content (“conditioned”), rolled up and packaged.

The inventive tubular food casing can be processed in a customary manner. It can, for example, be shirred to sticks or processed to give sections closed (generally sealed) at one end.

The filling is introduced into the casing thus produced. The filling is, for example, sausagemeat for scalded-emulsion sausage and cooked-meat sausage. Fillings which are not present in pasty form, such as ham, cured products and cheese, can generally be encased with the coated flat material, for which the use of a tubular casing is, though, not ruled out. With the aid of the inventive casing, these fillings can be provided with the transferable additives. After the carrier material of the casing has been peeled off, the coating comprising the additive remains on the surface of the filling.

The food casing finds use in accordance with the invention for the transfer of transferable additives to foods under the action of heat, at room temperature or even below. For example, it can be used in the production of cooked-meat sausage and scalded-emulsion sausage, but also for the finishing of ham, cured products and even cheese, for example melted cheese. Secondly, it is also suitable for the transfer of transferable additives to filling which is to be treated particularly gently, and to sensitive filling which has to be processed or stored under cooled conditions. Examples thereof are fish, fresh meat, but also cooked ham, scalded-emulsion sausage and cooked-meat sausage, and raw sausage.

The examples which follow serve to illustrate the invention. Percentages therein are to be understood as percentages by weight, unless stated otherwise or immediately apparent from the context.

### EXAMPLE 1

A cellulose casing of flat width 165 mm was produced by the known viscose spinning process, and the material was cut continuously with a sharp knife on a layflat edge. The roll of the cut casing, in a second process step, was opened up to give a flat material by means of a forming shoulder and coated with a 3% aqueous protein solution. Fine-grain paprika was applied to the coated side, and another layer of the 3% aqueous protein solution was laid onto it. The coated cellulose material was then dried in a drying channel at 90° C. (air temperature). Directly after the drying, the cellulose material was conducted over a further forming shoulder, which again shaped it into a round shape.

The longitudinal edges of the resulting material laid in a round shape were adhesive-bonded to one another with a PU-based extrusion adhesive. The tubular material thus produced was then rolled up and stored on the roll for 7 days. The casing was then dewatered cautiously from the outside, in order to make it more manageable, and filled with sausagemeat. The sausage thus obtained was cooked at 78° C. (core temperature), and the casing was subsequently peeled off. The result was a very visually appealing, red paprika coating on the surface of the meat sausage, without parts of the filling or of the spice remaining on the peeled-off casing.

### EXAMPLE 2

As described in example 1, a cellulose casing with a flat width of 140 mm was manufactured and cut, and the flat material was coated with a 2.5% aqueous methylcellulose solution. Dried parsley leaves were applied to this coating, and were then in turn coated with the aqueous methylcellulose solution.

After drying at 90° C. (air temperature) and shaping again to a round shape, the casing was adhesive-bonded together with a cyanoacrylate adhesive (LOCTITE® 401 from Henkel KgaA, Dusseldorf), cautiously dewatered from the outside and filled with ham. After cooking, the casing was peeled off.

A uniformly parsley-coated, cooked ham of appetizing appearance was obtained.

### EXAMPLE 3

A 5% milk protein solution adjusted to pH 9 (ROVITA® FN 5 from Rovita GmbH, Engelsberg, Germany) which contained 3% glycerol was applied with a coating knife to a polyamide film of size 50×60 cm, which gave a 15 μm-thick coating. Dried, cut parsley was scattered onto the still-moist layer and a thin fixing layer of the same alkaline milk protein solution was added on top of it. The coated film was dried at 80° C. for 1 minute.

A finished, cooked, shaped ham product was wrapped into this film coated in this way, and the wrapped product was placed again into the mold and stored at 7° C. for 24 hours. After this time, the product was removed from the mold and the film was unwrapped. This resulted in a visually very appealing shaped ham enrobed with parsley.

### EXAMPLE 4

A 3% aqueous methylcellulose solution (METHOCELL® A 150 from Georg Breuer GmbH) which contained 2.5% of 80% lactic acid as a preservative was applied with a coating knife to a starch-containing multilayer film with a structure (from the inside outward) of PA/(PE+AP)/(thermoplastic starch+PA 12) and of a size of 40×50 cm, which formed a layer with a thickness of 15 μm. Dried dill leaves were applied to the still-moist layer, and the film was dried at 70° C. for 50 seconds.

The film was wrapped around raw fish fillet which was stored, weighted with a light weight, at 5° C. for 24 hours. Thereafter, the fish fillet was removed from the film and was completely covered with dill.

### EXAMPLE 5

A 40% aqueous protein hydrolyzate solution was applied with a coating knife to a cellulose-coated fiber paper of size 30×50 cm, which resulted in a layer having a thickness of 20 μm. “Sweet” paprika was scattered evenly onto the still-moist layer, and a thin layer of the protein hydrolyzate solution was in turn applied on top of it. The paprika consisted of particles with a size of about 60 to 300 μm. On average, the particles had a size of about 100 μm. The fiber paper thus coated was dried at 100° C. for 1 minute.

A cooked ham was wrapped in the paper and stored with gentle pressure between two plates at 5° C. for 24 hours and, after this time, removed from the casing. This resulted in an appetizing ham enrobed with paprika.

### EXAMPLE 6

Example 5 was repeated with the difference that the carrier material used was polyamide and the additive used was peppercorns. After the cold storage, a pepper-enrobed cooked ham was obtained in impeccable quality.

### EXAMPLE 7

A woven fabric comprised of 100% viscose staple with a weight of 110 g/m² was coated with halogenized egg white (dry mass: 15%), in the course of which the protein was impressed into the fabric. An about 0.1 to 0.15 mm-thick layer was then applied on the fabric. Subsequently, coarse pepper was applied evenly to the layer. The material thus coated was then heated from below to a temperature of from 80 to 85° C., in order to irreversibly coagulate the protein. In order to additionally fix the spice layer, a thin protein layer was applied to the spice. Thereafter, the material was dried.

After the drying, the coated fabric provided with spices was shaped to a tube whose longitudinal edges were sewn together. The tubular casing was filled with pork sausagemeat. The filled casing was cooked in a hot-air oven up to a core temperature of 83° C. Subsequently, it was left to cool overnight.

After the removal of the casing, it was found that the spice had been transferred evenly and completely to the surface of the meat. The coagulated egg white remained on the fabric; another portion had become bonded to the meat.

1. A single- or multilayer food casing comprising (i) a carrier based on at least one water-insoluble, thermoplastic polymer, on a polymer of animal or vegetable origin or on regenerated or precipitated cellulose, and (ii) a coating which comprises a binder and at least one additive which is transferable to the filling, wherein the additive consists of fine to coarse foods or mixtures having a mean particle size of at least 60 μm.

2. The casing as claimed in claim 1, wherein said casing is flat or tubular, and the water-insoluble, thermo-plastic polymer is a polyolefin, polyamide, polyester, polyvinylidene chloride or polyvinyl chloride.

3. The casing as claimed in claim 1, wherein the carrier is a textile material, a film or a combination thereof.

4. The casing as claimed in claim 2, wherein the casing is tubular and the coating is disposed on the inside of the tube and the casing further has a longitudinal seam.

5. The casing as claimed in claim 1, wherein the binder is a protein, a polysaccharide, or a mixture thereof.

6. The casing as claimed in claim 5, wherein the protein is a protein coagulable under the action of heat, or a fraction produced or isolated therefrom.

7. The casing as claimed in claim 1, wherein the binder is one or more of a fat, wax, oil or another hydrophobic, water-insoluble substance which softens or becomes liquid under the action of heat up to about 90° C. thereby transferring the additive.

8. The casing as claimed in claim 1, said casing further comprising at least one outer coating.

9. The casing as claimed in claim 8, wherein the outer coating, after drying, has a weight of up to 150 g/m².

10. The casing as claimed in claim 1, wherein the additive has a firm consistency and comprises fine-grain to coarse-grain or piece-form particulate aromas and/or flavorings.

11. The casing as claimed in claim 10, wherein the aromas and/or flavorings are spices, herbs, vegetables, mushrooms, fruits, cereals, nuts and/or cheese.

12. The casing as claimed in claim 1, wherein said casing further comprises at least one additional food additive.

13. The casing as claimed in claim 1, wherein an additional binder layer covers and fixes the additive.

14. The casing as claimed in claim 13, wherein the additional binder layer comprises a film-forming substance.

15. A process for producing a food casing as claimed in claim 1, which comprises the following steps:
providing a tubular or web-form carrier material,
coating the carrier-material with a binder,
applying an additive,
optionally coating the carrier-material with additional binder
and
drying the coated carrier material.

16. The process as claimed in claim 15, wherein the additive is applied to coagulable protein which is then coagulated by the action of heat.

17. The process as claimed in claim 15, wherein a steam and/or oxygen barrier layer is applied to the side of the carrier material which is not provided with a binder.

18. The process as claimed in claim 15, wherein the carrier is provided in web-form said process further comprising (i) shaping the web-form into a tube with overlapping longitudinal edges, (ii) coating the binder and applying the additive on the inside of the tube, and (iii) fixing the overlapping edges with a seam.

19. The process as claimed in claim 15, wherein the carrier is tubular, said process further comprising coating the carrier on the outside, applying an additive, drying and, after drying, reversing the tubular casing, thereby resulting in an internally coated casing.

20. A method of transferring additives to foods comprising filling a food casing as claimed in claim 1 with food.

21. A process as claimed in claim 15, said process further comprising filling the dried carrier material with scalded-emulsion sausage, cooked-meat sausage, ham or cheese, and transferring the additives by heating the filled carrier material.

22. A process as claimed in claim 15, said process further comprising filling the dried carrier material with at least one of fish, meat, sausage products or cheese and transferring the additives below room temperature.

23. A process as claimed in claim 22, said process comprising filling the dried carrier material with raw-meat sausage or cooked ham.

24. The casing as claimed in claim 5, wherein the binder is casein or a protein hydrolyzate.

25. The casing as claimed in claim 5, wherein the binder is an ether or ester of cellulose.

26. The casing as claimed in claim 24, wherein the binder is methylcellulose.

27. The casing as claimed in claim 6, wherein the protein is whey protein, egg white protein or blood plasma.

28. The casing as claimed in claim 7, wherein the binder is tallow, drying oil, nondrying oil, semidrying oil, fatty acid, fatty acid ester, fatty alcohol or mixture thereof.

29. The casing as claimed in claim 8, wherein said outer coating comprises polyvinylidene chloride resin.

30. The casing as claimed in claim 9, wherein the outer coating has a weight ranging from 30 to 120 g/m².

31. The casing as claimed in claim 12, wherein the food additive is a colorant or liquid smoke.

32. The casing as claimed in claim 14, wherein the film-forming substance comprises the film-forming protein.

33. The casing as claimed in claim 14, wherein the film-forming substance comprises collagen fibers.

34. The casing as claimed in claim 19, wherein the tubular carrier is seamless.
